(19) United States
(12) Patent Application Publication
(10) Pub. No.: US 2007/0184552 A1
(43) Pub. Date: Aug. 9, 2007

(54) Apparatus and method for the detection of water in plants

(75) Inventor: Theodore B. Lynn, Hamden, CT (US)

Correspondence Address: FINCH & NGUYEN PLLC, P.O. BOX 1358, CONCORD, NH, 03302, US

(73) Assignee: Dexsil Corporation, Hamden, CT (US)

(21) Appl. No.: 10/978,837

(22) Filed: Nov. 1, 2004

(51) Int. Cl. B01L 3/00

(52) U.S. Cl. 436/39; 422/61

(57) ABSTRACT

A method and apparatus for determining moisture content in plants and portions of plants is provided. In one aspect, moisture can be determined by extracting water from a portion of a plant and reacting the resulting extract with an indicator to show qualitatively or quantitatively the presence of water in the plant material.

### BACKGROUND OF INVENTION

1. Field of Invention

The invention relates to the determination of water in living substances and, in particular, to the determination of water in plants.

2. Discussion of Related Art

With water becoming ever scarcer, the efficient use of water in agriculture is becoming an economic imperative. This is particularly true in areas where irrigation has become the primary source of water. There are numerous ways to optimize the amount of irrigation water applied to crops; many use estimations of soil moisture levels, either based on measurements of soil moisture at specific locations or rainfall data or visual inspection of the soil itself. To be useful, these estimates must be related back to the needs of the plants/crops. Sometimes a determination of the field capacity and the permanent wilt point for the soil type and plant combination are determined, and the actual amount of water needed is calculated from direct measurements, but, more often, the amount of water irrigated is derived from a timetable or an arbitrarily determined moisture level in the soil using historical data, experience and intuition.

One way to tie the irrigation levels to the health of plants is to measure the actual water content of the leaves of the plant. In practice this is not often done in the field because there is a lack of fast, accurate, field portable methods for making this determination. One instrument that has been adapted for use in the field is the Pressure Bomb. Also known as a Scholander-Hammel pressure bomb, this equipment is available commercially from PMS Instrument Company.

The pressure bomb technique is practiced by clamping a leaf inside of a pressure chamber with the cut end of the stem (petiole) sticking out. The pressure is increased inside the chamber until a drop of water forms on the stem. This pressure is then correlated to the “water stress” of the plant, the higher the pressure, the higher the stress. There is some debate as to the validity of this measurement and the correlation between the measured value and actual plant health is empirical.

Moisture level in plants may be important in non-agricultural applications as well. For example, construction lumber quality may be based, in part, on moisture content and in some applications, lumber should not be used unless it falls into a specific moisture range. Conductivity tests are typically used to measure moisture content in lumber, but these methods may lack precision and may vary with lumber type and source.

Some plant products are sold by weight and the amount of water contained in the products may affect the value of the product. For example, a coffee or tea buyer can make a more informed decision when the moisture content of a particular batch of product can be quickly determined.

Thus there is a need for improved field methods that can quickly and accurately provide information regarding the moisture content.

### SUMMARY OF INVENTION

The subject matter of this application may involve, in some cases, interrelated products, alternative solutions to a particular problem, and/or a plurality of different uses of a single system or article.

In one aspect, a method for measuring moisture in plant material is provided, the method comprising extracting at least water from at least a portion of a plant to produce an extract, reacting the extract with a water-reactive substance to produce a gas, determining an amount of gas produced, and determining the moisture content of the plant material.

In another aspect, a method for determining water content in plant material is provided, the method comprising providing a plant sample, mixing a solvent with the sample to produce an extract, and introducing an indicator to the extract to produce an indication from which the water content of the plant sample can be derived.

In another aspect, a kit for measuring water in plants is provided, the kit comprising an extraction tube, an extraction solvent, an indicator, and instructions for determining the water content of a plant sample.

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a cutaway view of a reaction tube and pressure testing instrument that can be used with the invention.

FIG. 2 provides a cutaway view of an extraction tube that can be used to extract water from plant material.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. Definitions used in this application are to be applied in preference to any conflicting definitions that may be in documents that are incorporated by reference herein.

As used herein, the term “determine” means to detect the presence of a substance either qualitatively or quantitatively. Thus, determine includes both detection and measurement.

“Alkali metals” include the traditional alkali metals from group 1a of the periodic table and also include elements from group 2, such as calcium and magnesium, that are capable of forming hydrides that react with water to form a gas. Specific alkali metals include sodium, potassium, lithium, calcium and magnesium. “Alkali metal compounds” include chemical compounds comprising at least one alkali metal atom.

An “indicator” is a substance that provides a detectable change in the presence of a target substance. The detectable change is an “indication” and may be determined with or without the help of instrumentation.

In one aspect, a method of determining the amount of water in plant tissue is provided. A portion of a plant, such as a leaf, can be extracted with a solvent that is at least partially miscible in water. After extraction, the resulting extract can be analyzed for water content and if the water content of the extract can be determined, then the water content of the plant sample can also be determined if, for instance, the amount of plant sample and the amount of solvent are known, are determinable, or can be estimated. One method of determining the amount of water in the solvent is to react the extract solvent with a reagent that reacts with water to provide an indication. For example, alkali metals and alkali metal compounds will react with water to produce a gas (hydrogen). Thus, compounds such as sodium metal and calcium carbide can react with an extract sample to produce a gas in a molar amount that corresponds to the amount of water in the extract. This gas production may be measured by, for example, an increase in volume and/or an increase in pressure and/or a further reaction with an additional indicator. In other embodiments, the indicator may be, for example, colorimetric and a color change may be measured either with the unaided eye or with the aid of instrumentation such as a spectrometer or colorimeter.

Any number of plant types and conditions can be analyzed. Plants may be dead or alive and samples may be taken from leaves, stems, roots, bark, wood, fruit, or any other part of the a plant. Plants tested may be, for example, crops (fruits, vegetables, tea, coffee, etc.), trees, lumber, firewood, pulpwood or grasses. Plants and plant portions can include the plants themselves as well as plant products, such as lumber, coffee, tea, textiles, etc. Plants can provide a matrix from which it is difficult to remove water, unlike some other matrices, such as oil or soil that, in most instances, can be efficiently extracted by shaking the sample with an extraction solvent. It is believe that much of the difficulty in extracting water from plants lies in the structure of the plant cell and, in particular, in the presence of a cell wall that provides a strong barrier to solvent break-through. This may be particularly true in cases where water-miscible solvents are used. While plant portions such as whole leaves may be extracted without physical pre-treatment, in some embodiments the plant portions are comminuted prior to extraction.

In one aspect, a portion of a plant is treated prior to or during the extraction procedure to render the water contained with the plant cells available to the extraction solvent. In some embodiments, this may be done by comminuting leaves, stems, roots or other plant portions into small pieces and then optionally grinding the pieces in the presence of an extraction solvent. Plant portions may be ground in any manner that helps to break open the plant cell walls. In one instance, the plant portion and solvent may be placed in a vessel such as, for example, a polymeric test tube. One or more grinding balls, such as steel shot, for example, are also placed in the vessel so that when the vessel is shaken the balls crush the plant cells against the bottom, top or sides of the tube, or between the balls themselves. Of course, the grinding balls need not be spherical and can be of any material capable of crushing plant cells upon shaking. These materials include, for example, metal, glass, stone and/or polymeric materials.

The plant or plant portions can be extracted with a solvent or mixture of solvents that is at least partially miscible with water. In some cases, the solvent may be infinitely miscible in water. In other cases, the solvent may be miscible in water at a ratio, by volume, of not less than, for example, 10:1, 5:1 or 2:1. Organic solvents may be used. Suitable organic solvents include, but are not limited to, alcohols, glycols, ethers, esters and substituted aliphatic, aromatic and cyclic compounds, such as THF and DMSO. Alcohols may include aliphatic and/or aromatic alcohols. In one embodiment, aliphatic alcohols are used and can be methanol, ethanol, propanol, isopropanol, butanol and/or isobutanol. Preferably, the alcohol used contains little or no water and may contain, for example, less than 1% water by volume. Anhydrous ethanol has been shown to provide good extraction efficiency.

Indication of water content can be performed either visibly, determined by human observation, or instrumentally, determined with the aid of instruments. In some embodiments, indicators can be chemicals that react with water to provide an indication, such as by a color change or the production of a substance, such as a gas. A color change can be detected visibly or instrumentally. The production of an indicator substance such as a gas may also be detected visibly or with the aid of instrumentation.

In one set of embodiments, the indicator is an alkali metal compound that is reacted with the extract solvent solution to produce a gas, for example, hydrogen. The alkali metal compound may be an alkali metal hydride such as calcium hydride. The indicator may be dissolved or dispersed in another substance, typically one that does not react with the indicator. For example, a dispersant may be a hydrocarbon based substance such as oil, or aromatic solvent, or both. Preferably, the dispersant is miscible or at least compatible with the extraction solvent that is used with the system. This can help, for example, in allowing the indicator to contact any water that is available in the extraction solvent. The use of a dispersant can also provide for more accurate, convenient and safe handling of solid indicators that, in solid form, are not easily pumped or quantitatively transferred to a storage capsule or reaction tube.

Indicators may be added to an extraction solvent in conventional ways such as by weighing or pipetting the indicator into the solvent or the solvent into the indicator. In some embodiments, the indicator is added to the extraction solvent in a closed vessel. For instance, when the indicator results in the production of a gas, the amount of gas produced may be more accurately measured in a closed vessel. However, a vessel must typically be open in order to add a reagent and this open period, even if of short duration, can allow for the escape of some gas upon the addition of the indicator. This may be of concern in some cases, such as when the reagent reacts quickly with any water, for example, when the indicator is an alkali metal compound.

In some embodiments, the indicator may be contained within a closed vessel but may be isolated from any extraction solvent. The indicator can then be introduced to the reaction solvent without opening the vessel to the atmosphere. For example, the vessel may be a flexible vessel, such as a polyethylene tube, and the indicator may be contained within a smaller vessel contained by the polyethylene tube. The smaller vessel may be breakable and may be, for example, a glass or plastic ampule. In some embodiments, the smaller vessel can be broken by squeezing the walls of the larger vessel in the vicinity of the smaller vessel.

Gas production may be measured in a number of ways. For example, an increase in volume and/or an increase in pressure may be detected. As dictated by the ideal gas law, a volume or pressure increase may be proportional to the amount of gas produced and therefore proportional to the amount of water reacted with the indicator. If a high percentage of the water present is reacted, or if the reaction efficiency is known, the amount of water in a sample can be accurately calculated from measuring the gas production. In some embodiments, gas production, and therefore water content, can be determined by measuring an increase in pressure. Portions of a plant are weighed and placed in an extraction vessel. A known amount of extraction solvent, for example, absolute ethanol, is added to the extraction vessel and water is extracted from the plant portion into the extraction solvent. Extraction may be aided by agitation, such as by shaking, and/or by macerating the plant material, such as by shaking with one or more steel balls. A portion of the extraction solvent can then be separated from some or all of the plant portion and is transferred to an indicator vessel or device. Alternatively, the indication may take place in the same vessel as the extraction. The indication vessel may be sealed and an indicator introduced to the extraction solvent by crushing a glass ampule housed inside the indication vessel and containing an indicator, such as a calcium hydride dispersion. The resulting mixture may then be agitated if helpful, such as by shaking, until any water that is present has had an opportunity to react with the calcium hydride. Given that the indicator vessel may be of a small, fixed volume, a detectable increase in pressure will result. This pressure may be measured in a number of ways, such as by directly measuring the pressure in the vessel or by measuring the increased resistance to compressing a flexible-walled vessel. In some embodiments, the vessel may include a septum through which a probe, such as a pressure pin (hypodermic needle), can be introduced. The probe can place the interior of the vessel in fluid communication with a pressure sensor, such as a pressure transducer. The resulting pressure can be measured by the pressure sensor and the resulting change in pressure (from atmospheric) can be correlated to the amount of water in the extraction solvent and, in turn, the amount of water in the plant portion. The amount of water can be determined manually or automatically via a microprocessor and can be reported in any useful units, such as, for example, micrograms, milligrams, percentage, parts per million (ppm) or a volume or weight ratio.

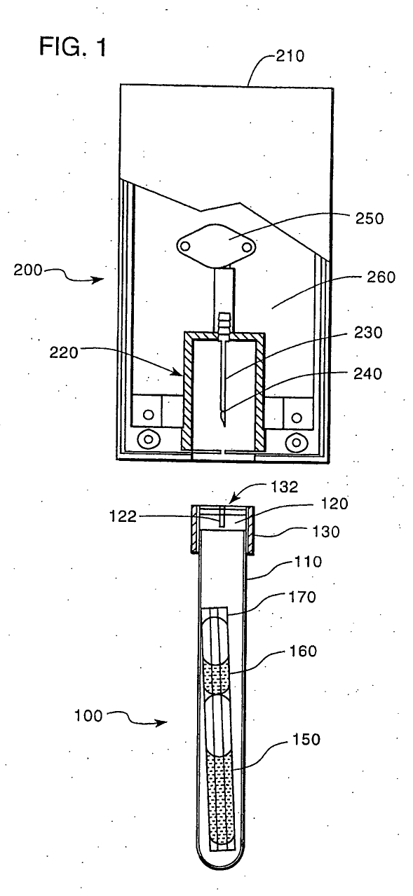

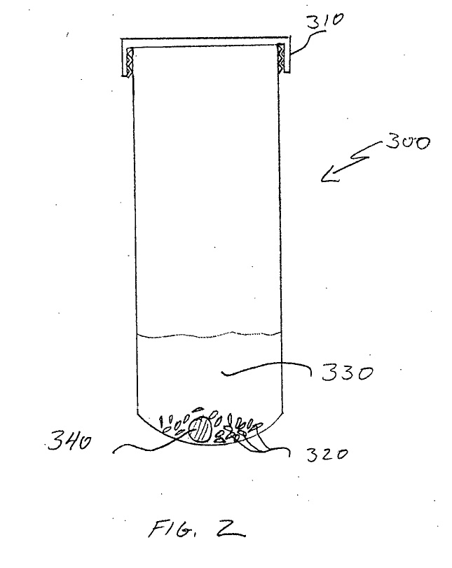

An apparatus for measuring the water content in plants is provided in FIGS. 1 and 2. FIG. 2 provides a cutaway view of a 50 mL polypropylene extraction tube 300 including a screw cap 310. About one gram of a plant portion 320, comminuted, is added to the tube. About 10.5 mL of dry ethanol 330 is also added to the tube. The ethanol can be stored and shipped in a screw-top or break-top vial prior to use. Alternatively, the solvent can be simply pipetted into the reaction tube from a bulk source. A steel ball bearing 340 is also added to the extraction tube. After the cap 310 has been replaced, the tube is shaken for several minutes providing agitation and an opportunity for the ball bearing to macerate the plant portion. The mixture is allowed to settle for several minutes to allow the plant material to sink to the bottom of the tube while any extracted water is retained in solution. The presence of a distinct green color in the extract solution indicates an efficient extraction of water from the plant cells. After settling, 250 uL of representative extraction solvent is transferred to a reaction tube 100, as shown in FIG. 1.

A pressure fit stopper 120 (septum) is then placed into the top of the tube by firmly seating it into the opening. A screw cap 130 with a circular orifice 132 in the middle is tightened onto the threads of the tube forming a seal between the cap 130, stopper 120 and the interior surface of the opening of the tube.

A calcium hydride suspension is produced by suspending 84 mg of calcium hydride in 0.5 mL mineral oil to produce a 20% suspension. This suspension is then diluted to improve flow by adding 1.0 mL of “high flash” aromatic solvent, such as a commercially-available aromatic solvent having a flash point of greater than 150° F. (>65.6° C.). A frangible glass ampule 150 containing calcium hydride and a disposal ampule (water) 160 are both supported in tube 110 by a compressible polypropylene holder 170. The calcium hydride ampule 150, containing 420 milligrams of calcium hydride suspension in 1.0 mL of aromatic solvent, is broken by squeezing the sides of the polyethylene reaction tube in the vicinity of the glass ampule. The breakage of the glass ampule introduces the calcium hydride to the extract. The extract and the calcium hydride are then mixed together by shaking the tube vigorously for about 30 seconds. The tube is allowed to stand for about 1.5 minutes and then shaken again for about another 30 second period. The mixture is then allowed to stand for an additional 30 seconds.

A pressure meter 200 (HYDROSCOUT® test meter, Dexsil Corporation, Hamden, Conn.) was set for “program F” and the display on the LCD readout 210 of the meter read “tube.” The capped end of the tube was then firmly fitted into the sleeve 220 of the meter 200 allowing pressure pin 230 to puncture the septum at guide 122 that passes a portion of the distance through stopper 120. The pressure pin 230 was then allowed to communicate with the interior of the reaction tube via the pressure port 240 and the lumen of the pressure pin. Pressure pin 230 also communicated with pressure transducer 250 that in turn provided a signal to printed circuit board 260. The “read” button on the meter 200 was pressed and after displaying the word “calc” for several seconds, the results were displayed in milligrams of water.

After completion of the test procedure, disposal ampule 160 can be broken to introduce excess water into the reaction tube. The water reacts with any calcium hydride that remains, thus allowing the reaction tube contents to be more easily disposed of.

The function and advantage of these and other embodiments of the present invention will be more fully understood from the examples below. The following examples are intended to illustrate the benefits of the present invention, but do not exemplify the full scope of the invention.

### EXAMPLES

The following examples illustrate methods for determining water content in various types of plants. In each example, the indicator is calcium hydride and the amount of water in the sample is determined by measuring gas production which is detected by an increase in pressure. The pressure change can be detected (pressure method) using a HYDROSCOUT meter, available from Dexsil Corporation, Hamden, Conn. The HYDROSCOUT meter, as currently available, is calibrated for measuring water in solids and includes a 16% correction factor to compensate for less than complete extraction in solid samples. As shown below, the extraction efficiency using the methods described herein is typically more efficient and thus the results provided typically indicate recoveries of greater than 100%. When not described otherwise, the techniques used are the same as those described in U.S. patent application Ser. No. 10/847,553, the contents of which are hereby incorporated by reference herein.

In the examples shown below, the following procedure was used. A leaf or number of leaves were chopped or cut into small pieces having a width across the piece of about 3 mm. Individual leaves were rolled up and small pieces were sequentially removed (cut with scissors) until enough sample was obtained. Target sample size was 1 gram with the actual mass being recorded. The sample was placed in a 50 mL polypropylene extraction tube. To each tube, a ½″ stainless steel ball bearing and 10.5 mL of ethanol were added. The tube was capped and shaken vigorously by hand for 3 minutes and then allowed to settle for 2 minutes. 0.25 mL of extraction solvent was then removed from the tube using a calibrated pipette and the solvent sample was added to a polyethylene reaction tube including a crushable ampule containing 420 mg of calcium hydride dispersed in 1 mL of aromatic solvent. The ampule was crushed by squeezing the sides of the tube and the mixture was allowed to react for 3 minutes, with intermittent shaking, before measuring the pressure increase with the HYDROSCOUT meter, set to “Program F.” Some examples also include measurements on different plants were made with and without the ball bearing and with extracting the leaves for different times. Because the instrument was programmed to compensate for less than perfect extraction efficiency for other matrices, all results have been mathematically adjusted to remove this correction factor. Thus, the results provided below are based on an assumption of 100% extraction efficiency and the application of the ideal gas law to the relationship between the increase in pressure and the amount of water in the plant sample. No correction factor has been used, although one could be programmed into the instrument to improve accuracy beyond what is shown here. Precision would be essentially unaffected. “Instrument output” or “instrument reading” is in units of milligrams water. “Sample weight” is in grams.

### Example 1—

In the first experiment leaves from Japanese knotweed, or Fallopia japonica (Polygonum cuspidatum), known in Japan as itadori, or “strong plant” and Sycamore maple, Acer pseudoplatanus L. were collected and immediately prepared for analysis. Prior to stacking in groups of five for chopping, the leaf midrib and petiole were removed by folding the leaves (one at a time) along the mid rib and cutting the rib and petiole off. Five leaves were stacked and rolled into a tight cylinder so that they could be cut using sharp scissors, cutting off a scissor-blade width at a time. The chopped leaves were then weighed (approximately 1 gram aliquots) into 50 mL pp soil extraction tubes. Each leaf type was analyzed in triplicate and the remainder was weighed into two aluminum trays for duplicate oven dry gravimetric determinations of water content. The water content determined by the oven-dry technique was deemed to be the actual water content.

The results shown in Table 1 were achieved using a 3 minute shake time, followed by a 30 minute settling time. Extraction solvent from each extraction tube was sampled in duplicate. The results for two varieties of leaves are provided below.

TABLE 1

| | | Sample | Instrument | Water | | Percent | Std. | Oven Dry % |
|---|---|---|---|---|---|---|---|---|
| Sample Type | Sample ID | Weight | Reading | Cont. % | Ave. | Recovery | Dev | Ave. |
| Maple | 1-a | 1.13 | 691 | 61.2 | | | | |
| Maple | 1-a | 1.13 | 688 | 60.9 | | | | |
| Maple | 1-b | 1.25 | 703 | 56.3 | | | | |
| Maple | 1-b | 1.25 | 709 | 56.8 | | | | |
| Maple | 1-c | 1 | 590 | 59.0 | | | | |
| Maple | 1-c | 1 | 588 | 58.8 | 58.8 | 106 | 2.02 | 55.5 |
| Bamboo | 3-a | 1.09 | 779 | 71.5 | | | | |
| Bamboo | 3-a | 1.09 | 772 | 70.8 | | | | |
| Bamboo | 3-b | 0.95 | 683 | 71.9 | | | | |
| Bamboo | 3-b | 0.95 | 679 | 71.5 | | | | |
| Bamboo | 3-c | 0.95 | 689 | 72.5 | | | | |
| Bamboo | 3-c | 0.95 | 677 | 71.2 | 71.6 | 102 | 0.59 | 69.8 |

The oven dry results, determined after drying the samples overnight at 105° C., are tabulated below in table 2.

TABLE 2

| Sample | | Wet wt. | Dry wt. | Tare | water |
|---|---|---|---|---|---|
| Type | Tray | total | Total | wt. | % |
| Maple | 1 | 17.5 | 14.7 | 12.5 | 56.00 |
| Maple | 2 | 18.4 | 15.1 | 12.4 | 55.00 |
| Bamboo | 3 | 20.12 | 14.86 | 12.53 | 69.30 |
| Bamboo | 4 | 24.28 | 16 | 12.5 | 70.29 |

### Example 2—

The above experiment was repeated using the knotweed (bamboo) leaves in triplicate. This time a ½″ stainless steel ball bearing was added to the extraction tube. The tube was shaken for 6 minutes and allowed to sit for 15 minutes. The extract was again sampled in duplicate and analyzed. The results are tabulated below.

TABLE 3

| | | | Instru- | | | | |
|---|---|---|---|---|---|---|---|
| Sample | Sample | Sample | ment | Water | | Percent | Std |
| Type | ID | Weight | Reading | Cont. % | Ave. | Recovery | Dev |
| Bamboo | 1bb | 0.98 | 665 | 67.8 | | | |
| Bamboo | 1bb | 0.98 | 668 | 68.2 | | | |
| Bamboo | 2bb | 0.98 | 699 | 71.3 | | | |
| Bamboo | 2bb | 0.98 | 661 | 67.5 | | | |
| Bamboo | 3bb | 1.05 | 692 | 65.9 | | | |
| Bamboo | 3bb | 1.05 | 678 | 64.5 | 67.5 | 96.8 | 2.30 |

The above preliminary experiments indicate that the recovery of water from the leaves is substantially complete.

### Example 3—

To determine the effect of extraction time and the shaking with a ball bearing, an experiment was run on the bamboo leaves varying the extraction times from 5 min to 20 minutes with and without the ball bearings. The results tabulated below indicate that the use of the ball bearings shortens the required extraction time.

TABLE 4
Extraction Without Ball Bearing

| Weight | Shake | Extract | mg Water | mg Water | Percent | |
|---|---|---|---|---|---|---|
| bamboo | time | time | trial 1 | trial 2 | Water | Average |
| 1.0068 | 3 min | 5 min | 399 | 309 | 39.1 | |
| 0.9766 | 3 min | 5 min | 385 | 386 | 39.5 | |
| 0.992 | 3 min | 5 min | 385 | 396 | 39.4 | 39.3 |
| 0.9916 | 3 min | 10 min | 461 | 480 | 47.5 | |
| 0.999 | 3 min | 10 min | 527 | 509 | 51.9 | |
| 1.0336 | 3 min | 10 min | 502 | 510 | 49.0 | 49.4 |
| 1.0257 | 3 min | 20 min | 628 | 628 | 61.2 | |
| 0.9955 | 3 min | 20 min | 617 | 619 | 62.1 | |
| 0.9929 | 3 min | 20 min | 596 | 600 | 60.2 | 61.2 |

Extraction With Ball Bearing

| Weight | shake | extract | mg water | mg water | Percent | |
|---|---|---|---|---|---|---|
| Bamboo | time | time | trial 1 | trial 2 | Water | Average |
| 1.0191 | 3 min | 5 min | 705 | 698 | 68.8 | |
| 1.0042 | 3 min | 5 min | 675 | 673 | 67.1 | |
| 0.9964 | 3 min | 5 min | 634 | 672 | 65.6 | 67.2 |
| 1.0104 | 3 min | 10 min | 655 | 642 | 64.2 | |
| 1.0205 | 3 min | 10 min | 660 | 674 | 65.4 | |
| 1.0518 | 3 min | 10 min | 670 | 681 | 64.2 | 64.6 |

### Example 4—

In addition to woody plants and weeds, some leafy crops, which are readily available in the grocery store, were tested. These vegetables were chosen as a complement to the above because they are known to contain a high percentage of water and would demonstrate the applicability of the methods on row crops that require large amounts of water, in most cases irrigation water. The vegetables tested and compared to the oven dry method were curly mustard greens, turnip greens and iceberg lettuce. The results tabulated below indicate that the method provides accurate results for high water content plants.

TABLE 5

| Curly Mustard Greens | | | mg | | | | |
|---|---|---|---|---|---|---|---|
| | | Ex- | Wa- | mg | | Oven | |
| Weight | Shake | tract | ter | Water | Percent | Dry % | Percent |
| Sample | time | time | trial 1 | trial 2 | Water | Water | Recovery |
| 1.0305 | 3 min | 5 min | 880 | 879 | 85.4 | | |
| 1.0192 | 3 min | 5 min | 834 | 878 | 85.0 | | 96.8 |
| 1.0184 | 3 min | 5 min | 896 | 875 | 86.9 | 88.20 | |
| | | | | Ave | 85.4 | | |

TABLE 6

| Fresh Turnip Greens | | | mg | | | | |
|---|---|---|---|---|---|---|---|
| | | Ex- | Wa- | mg | | Oven | |
| Weight | Shake | tract | ter | Water | Percent | Dry % | Percent |
| Sample | time | time | trial 1 | trial 2 | Water | Water | Recovery |
| 1.0532 | 3 min | 5 min | 983 | 971 | 91.3 | | |
| 1.0742 | 3 min | 5 min | 941 | 904 | 85.3 | | 100 |
| 0.9667 | 3 min | 5 min | 859 | 880 | 89.9 | 88.90 | |
| | | | | Ave | 89.1 | | |

TABLE 7

| | | | mg | | | | |
|---|---|---|---|---|---|---|---|
| Iceberg Lettuce | | Ex- | Wa- | mg | | Oven | |
| Weight | Shake | tract | ter | Water | Percent | Dry % | Percent |
| Sample | time | time | trial 1 | trial 2 | Water | Water | Recovery |
| 1.0387 | 3 min | 5 min | 984 | 958 | 93.5 | | |
| 1.0244 | 3 min | 5 min | 973 | 990 | 95.8 | | |
| 0.9192 | 3 min | 5 min | 869 | 876 | 94.9 | | |
| | | | | Ave | 94.7 | 96.83 | 97.8 |

### Example 5—

As a test of how well the method can track the moisture content in a particular leaf type over a range of water contents, a bamboo plant was cut and allowed to dry out/wilt. Over the course of a week, samples of leaves were taken and the water content was determined using the previously described methods and the oven dry method. The results for the first attempt at this are tabulated below. Some of the oven dry results are missing due to experimental errors.

TABLE 8

| | | | mg | mg | | Oven | |
|---|---|---|---|---|---|---|---|
| Weight | Shake | Extract | Water | Water | Percent | Dry % | Percent |
| Bamboo | time | time | trial 1 | trial 2 | Water | Water | Recovery |
| 0 hr Bamboo Leaves | | | | | | | |
| 1.0191 | 3 min | 5 min | 705 | 698 | 68.8 | | |
| 1.0042 | 3 min | 5 min | 675 | 673 | 67.1 | | |
| 0.9964 | 3 min | 5 min | 634 | 672 | 65.6 | NA | NA |
| | | | | Ave. | 67.2 | | |
| | | | | Std. Dev. | 1.64 | | |
| 48 hr Bamboo Leaves | | | | | | | |
| 1.0074 | 3 min | 5 min | 590 | 593 | 58.7 | | |
| 1.00339 | 3 min | 5 min | 580 | 593 | 58.5 | | |
| 1.0041 | 3 min | 5 min | 609 | 613 | 60.8 | 61.70 | 96.2 |
| | | | | Ave. | 59.3 | | |
| | | | | Std. Dev. | 1.30 | | |
| 72 hr Bamboo Leaves | | | | | | | |
| 1.0079 | 3 min | 5 min | 417 | 425 | 41.8 | | |
| 0.948 | 3 min | 5 min | 393 | 396 | 41.6 | | |
| 1.0426 | 3 min | 5 min | 440 | 433 | 41.8 | NA | NA |
| | | | | Ave. | 41.8 | | |
| | | | | Std. Dev. | 0.095 | | |
| 144 hr Bamboo Leaves | | | | | | | |
| 0.9963 | 3 min | 5 min | 83 | 84 | 8.35 | | |
| 1.0233 | 3 min | 5 min | 83 | 83 | 8.09 | | |
| 1.0055 | 3 min | 5 min | 83 | 85 | 8.36 | 10.70 | 77.3 |
| | | | | Ave. | 8.27 | | |
| | | | | Std. Dev. | 0.16 | | |

The very low moisture content of the 144 hr. Bamboo sample affects the percent recovery, but all other test results showed that the pressure method differed from the gravimetric method by only 1.1%. Looking at all of the results, this variation is equal to about 1 standard deviation.

### Example 6—

In an experiment designed to test wood and woody parts of plants, samples of wood chips were taken from a freshly cut smooth sumac sapling (Rhus glabra) using 1) a chainsaw and 2) a ½ inch drill bit. In both cases the chips were collected in a plastic bag. From the collected chips aliquots were taken for analysis by the pressure method and oven dry methods. The last column shows the percent recovery based on the instrument reading divided by the oven dry result.

TABLE 9

| amt | | | | | | test method | |
|---|---|---|---|---|---|---|---|
| sumac | | | | | | minus oven | |
| chain | instrument | % | avg % | | oven dry | dry method | % recovery |
| saw | output | H2O | H2O | std dev | % H2O | (%) | % recover |
| 1.0868 | 427 | 39.3 | | | | | |
| 0.9608 | 383 | 39.8 | | | | | |
| 1.1745 | 466 | 39.6 | 39.6 | 0.29 | 41.6 | −2.0 | 95.1 |
| amt | | | | | | | |
| sumac | instrument | % | | | oven dry | | |
| ½″ drill | output | H2O | avg | std dev | % H2O | | % recover |
| 1.1611 | 441 | 38.0 | | | | | |
| 1.0828 | 416 | 38.4 | | | | | |
| 1.028 | 414 | 40.3 | 38.9 | 1.23 | 41.9 | −3.0 | 92.8 |

### Example 7—

The measurement of moisture content of wood is also used by the forest service to determine the risk of fire. Typically, dead wood is tested by slicing a thin disk from a dead tree and determining the moisture content by oven dry method. The present method was tested on dead wood to determine the applicability of the method in this field. A dead, 5″ diameter, white oak log (Quercus alba) was sliced using a chain saw and the chips were collected for analysis as above. Results are provided below in table 10.

TABLE 10

| | | | | | | test method | |
|---|---|---|---|---|---|---|---|
| amt | instru- | | | | oven | minus | % |
| hard- | ment | % | | std | dry | oven dry | recov- |
| wood | output | H2O | avg | dev | % H2O | method (%) | ery |
| 1.4784 | 478 | 32.4 | | | | | |
| 1.5312 | 490 | 32.0 | | | | | |
| 1.387 | 452 | 32.6 | | | | | |
| 1.5204 | 471 | 31.0 | | | | | |
| 1.5107 | 488 | 32.3 | | | | | |
| 1.3537 | 450 | 33.2 | | | | | |
| 1.572 | 484 | 30.8 | 32.0 | 0.87 | 31.4 | 0.60 | 102 |

### Example 8—

As a further test on drier wood, the oven dried chips were allowed to reach equilibrium with the ambient air and were reanalyzed. Results are provided in Table 11.

TABLE 11

| | | | | | | test | |
|---|---|---|---|---|---|---|---|
| | | | | | | method | |
| | | | | | | minus | |
| | | | | | | oven | |
| | instru- | | | | oven | dry | |
| amt | ment | % | | | dry | method | % |
| chips | output | H2O | avg | std dev | % H2O | (%) | recovery |
| 1.3169 | 87 | 6.61 | | | | | |
| 1.2538 | 90 | 7.22 | | | | | |
| 1.4352 | 102 | 7.15 | | | | | |
| 1.5163 | 95 | 6.25 | 6.81 | 0.46 | 8 | −1.19 | 85.1 |

### Example 9—

The method was also tested on high water content celery stalks. The stalks were split lengthwise and sliced crosswise using a razorblade. The slices were divided and analyzed by both methods. Results are shown in table 12.

TABLE 12

| | | | | | | test | |
|---|---|---|---|---|---|---|---|
| | | | | | | method | |
| | | | | | | minus | |
| | | | | | | oven | |
| | instru- | | | | oven | dry | |
| amt | ment | % | | | dry | method | % |
| celery | output | H2O | avg | std dev | % H2O | (%) | recovery |
| 1.8096 | 1538 | 85.0 | | | | | |
| 1.4197 | 1267 | 89.2 | | | | | |
| 1.4447 | 1272 | 88.0 | | | | | |
| 1.485 | 1290 | 86.8 | | | | | |
| 1.5482 | 1386 | 89.5 | | | | | |
| 1.5074 | 1333 | 88.4 | | | | | |
| 1.3111 | 1216 | 92.7 | 88.5 | 2.40 | 95.9 | −7.4 | 92.3 |

### Example 10—

As above in Example 5, a bamboo plant was cut and allowed to wilt over time. The leaf moisture was measured at various intervals using the pressure method and oven dry method.

The results, shown below in table 13, show good agreement between the two methods. Note that as the water content drops to near 10% by weight that the precision of the method becomes a factor and affects the percent recovery calculation. The results indicate that the pressure method provides accurate results across a wide range of moisture levels. It is believed that an increase in the amount of reaction solvent removed from the reaction tube or an increase in the plant sample size, and a corresponding adjustment in the instrument output, would result in improved recoveries at the lower levels.

TABLE 13

| | | | | Oven | |
|---|---|---|---|---|---|
| | instrument | instrument | | Dry | pressure |
| amt | output | output | | % | method |
| leaves | trial 1 | trial 2 | | Water | % recov |
| 0 hrs bamboo leaves | | | | | |
| 1.0369 | 691 | 681 | 66.2 | | |
| 1.0227 | 660 | 662 | 64.6 | | |
| 0.9991 | 627 | 634 | 63.1 | 70.9 | 91.2 |
| avg | | | 64.6 | | |
| std dev | | | 1.55 | | |
| 24 hrs bamboo leaves | | | | | |
| 1.0018 | 357 | 372 | 36.4 | | |
| 1.0369 | 370 | 372 | 35.8 | | |
| 1.0278 | 370 | 359 | 35.4 | 35.4 | 101 |
| avg | | | 35.9 | | |
| std dev | | | 0.49 | | |
| 48 hrs bamboo leaves | | | | | |
| 1.0296 | 115 | 102 | 10.5 | | |
| 1.0051 | 99 | 103 | 10.1 | | |
| 1.0201 | 101 | 104 | 10.1 | 11.6 | 88.0 |
| avg | | | 10.21 | | |
| std dev | | | 0.26 | | |
| 72 hrs bamboo leaves | | | | | |
| 1.0148 | 93 | 94 | 9.2 | | |
| 1.0229 | 85 | 84 | 8.2 | | |
| 1.024 | 64 | 83 | 7.2 | 11.2 | 73.3 |
| avg | | | 8.2 | | |
| std dev | | | 1.03 | | |
| 96 hrs bamboo leaves | | | | | |
| 0.998 | 99 | 97 | 9.84 | | |
| 1.0242 | 88 | 94 | 8.88 | | |
| 1.0174 | 96 | 106 | 9.91 | 12.1 | 78.9 |
| avg | | | 9.54 | | |
| std dev | | | 0.58 | | |

### Example 11—

To check the variability of the method versus the variation among leaf samples, results for individual leaves were measured and compared to measurements of pooled leaves.

TABLE 14

| | | |
|---|---|---|
| amt bamboo | instrument output | % H2O |

Pressure method on individual bamboo leaves

| | | |
|---|---|---|
| 1.0407 | 669 | 64.3 |
| 1.025 | 659 | 64.2 |
| 0.9818 | 681 | 69.4 |
| 1.008 | 660 | 65.5 |
| 1.0382 | 695 | 66.9 |
| 0.9937 | 700 | 70.5 |
| 1.0161 | 669 | 65.8 |
| avg | | 66.7 |
| std dev | | 2.44 |

Pressure method on combined/mixed bamboo leaves

| | | |
|---|---|---|
| 1.0177 | 616 | 60.5 |
| 1.037 | 641 | 61.8 |
| 0.9979 | 594 | 59.5 |
| 1.0145 | 668 | 65.8 |
| 1.038 | 676 | 65.1 |
| 0.9979 | 636 | 63.8 |
| 1.015 | 655 | 64.55 |
| avg | | 63.0 |
| std dev | | 2.43 |

The variation within the pooled leaves is higher than expected and is the same as the variation between leaves.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B”, when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of measuring moisture in plant material comprising:
extracting at least water from at least a portion of a plant to produce an extract;
reacting the extract with a water-reactive substance to produce a gas;
determining an amount of gas produced; and
determining the moisture content of the plant material.

2. The method of claim 1 wherein the portion of a plant is a leaf or a portion of a leaf.

3. The method of claim 1 wherein the plant portion is reduced to a plurality of plant portion pieces.

4. The method of claim 1 wherein water is extracted using a solvent.

5. The method of claim 4 wherein the solvent is an organic solvent.

6. The method of claim 5 wherein the organic solvent is an alcohol.

7. The method of claim 6 wherein the alcohol is ethanol.

8. The method of claim 1 further comprising macerating the portion of the plant.

9. The method of claim 8 wherein the portion of the plant is pulverized in the presence of an extraction solvent.

10. A method for determining water content in plant material comprising:
providing a plant sample;
mixing a solvent with the sample to produce an extract; and
introducing an indicator to the extract to produce an indication from which the water content of the plant sample can be derived.

11. The method of claim 10 wherein the indication is the production of a gas.

12. The method of claim 10 wherein the indicator is selected from calcium carbide, calcium hydride and sodium.

13. The method of claim 12 wherein the indicator is calcium hydride.

14. The method of claim 10 further comprising extracting at least 80% of the water in the plant sample into the solvent.

15. The method of claim 10 further comprising introducing the indicator to the solvent in a sealed compartment.

16. The method of claim 15 wherein at least a portion of the compartment is flexible.

17. The method of claim 16 wherein the maximum volume of the compartment is fixed.

18. The method of claim 11 wherein a gas is produced and the amount of gas produced is determined by measuring the pressure in the compartment.

19. The method of claim 18 wherein the pressure is measured externally of the compartment.

20. The method of claim 18 wherein the volume of the compartment is less than 100× the volume of the amount of extract to which the indicator is added.

21. The method of claim 15 wherein the compartment comprises a septum.

22. The method of claim 21 further comprising piercing the septum with a probe.

23. The method of claim 22 wherein the probe is in fluid communication with a pressure sensor.

24. The method of claim 23 wherein the pressure sensor is a pressure transducer.

25. The method of claim 24 wherein the pressure transducer provides a signal to a microprocessor.

26. The method of claim 25 wherein the microprocessor converts the signal to an amount of water.

27. The method of claim 26 further comprising the step of inputting a sample size into the microprocessor.

28. The method of claim 10 wherein the plant sample is a representative sample.

29. The method of claim 28 further comprising reducing the plant sample to pieces having a surface area of less than 0.25 cm².

30. The method of claim 29 wherein the plant sample comprises a leaf or a portion of a leaf.

31. A kit for measuring water in plants, the kit comprising:
an extraction tube;
an extraction solvent;
an indicator; and
instructions for determining the water content of a plant sample.

32. The kit of claim 31 wherein the indicator comprises calcium carbide.

33. The kit of claim 31 comprising a pressure meter.

34. The kit of claim 34 comprising a balance.

35. The kit of claim 31 comprising an indicator tube.
